(19) United States
(12) Patent Application Publication
(10) Pub. No.: US 2013/0280399 A1
(43) Pub. Date: Oct. 24, 2013

(54) MALT BEVERAGE HAVING REDUCED WORT OFF-FLAVOR AND PROCESS FOR PRODUCTION THEREOF

(71) Applicants: Atsushi Murakami, Yokohama-shi (JP); Yumiko Kawasaki, Yokohama-shi (JP); Reiko Ohta, Kita-ku (JP); Junichi Furukawa, Yokohama-shi (JP)

(72) Inventors: Atsushi Murakami, Yokohama-shi (JP); Yumiko Kawasaki, Yokohama-shi (JP); Reiko Ohta, Kita-ku (JP); Junichi Furukawa, Yokohama-shi (JP)

(73) Assignee: KIRIN BEER KABUSHIKI KAISHA, Nakano-ku, Tokyo (JP)

(21) Appl. No.: 13/885,822

(22) PCT Filed: Nov. 16, 2011
(86) PCT No.: PCT/JP2011/076369

§ 371 Date: Jun. 25, 2013

(30) Foreign Application Priority Data
Nov. 17, 2010 (JP) 2010-257132
Nov. 17, 2010 (JP) 2010-257146

(51) Int. Cl. A23L 2/56

(52) U.S. Cl. CPC A23L 2/56
USPC 426/534

(57) ABSTRACT

A production process of an alcohol-free beer-like malt beverage is disclosed. The process comprises reducing the off-flavor originated from wort by adding terpene. The process provides an alcohol-free beer-like malt beverage having an unpleasant wort off-flavor reduced.

### CROSS-REFERENCE TO RELATED APPLICATIONS

The present patent application accompanies a claim of priority based on Patent Applications No. 2010-257132 (filed on Nov. 17, 2010) and No. 2010-257146 (filed on Nov. 17, 2010), both previously applied for in Japan, which are incorporated herein by reference in their entirety.

### TECHNICAL FIELD

The present invention relates to an alcohol-free beer-like malt beverage having a wort off-flavor reduced by addition of terpene and a process for production thereof.

### BACKGROUND ART

An increasing number of consumers are self-controlling alcohol intake in a recent trend of health-oriented consciousness. In addition, people who drive automobiles and the like are more concerned about alcohol intake than before, due to the revision of Road Traffic Act including reinforcement of penal regulations against drunk driving. In such situation, demand for low-alcohol or alcohol-free beer-flavored malt beverage is markedly increasing.

Conventional low-alcohol beer-flavored malt beverage is produced by yeast fermentation to give a beer flavor to the beverage similarly to usual beer, while attempting to reduce alcohol, because it has been considered difficult to produce low-alcohol malt beverage completely excluding alcohol fermentation in order to satisfy consumers who expect beer-like taste and flavor. Therefore, assuming that conventional low-alcohol beer-flavored malt beverage is produced by yeast fermentation, modification of metabolic process with yeast and methods to effectively remove alcohol from the fermentation product have been investigated.

For example, Japanese Patent Application Laid-Open Publication No. 2005-13142 (Patent Document 1) discloses the production of low-alcohol beverage by aeration or gas aeration during fermentation. WO2004/018612 (Patent Document 2) discloses a method to give a beer-like flavor to diluted beer or low-alcohol malt beverage by adding a specific substance.

However, unfermented wort has a peculiar flavor (wort flavor), which adversely affects even the taste by producing aftertaste upon drinking. The wort flavor originates from aldehydes generated during the feeding process of the wort, especially by heat decomposition at boiling, and is known as a causative substance of candy-like smell, grain-like smell, and so on. These aldehydes are metabolized by yeast and drastically reduced during fermentation process in the case of usual beer. On the contrary, malt beverage produced without yeast fermentation or with suppressed fermentation has off-flavor originated from wort and generally not suitable for drinking.

Although Japanese Patent Application Laid-Open Publication No. 2003-250503 (Patent Document 3) discloses a beer-flavored carbonated beverage produced by adding malt extract and sugars, beer concentrate is prepared from beer by removing alcohol by reduced-pressure distillation and the like and very little amount of malt extract is added to it for flavoring in this publication. Means to reduce off-flavor in the unfermented wort is not disclosed.

On the other hand, WO2010/079643 (Patent Document 4) discloses a method for producing a beer-flavored malt beverage mainly composed of unfermented wort. This publication discloses the treatment of wort with adsorbent such as activated carbon in order to reduce unpleasant wort flavor.

### CITATION LIST

### Patent Document

Patent Document 1: Japanese Patent Application Laid-Open Publication No. 2005-13142
Patent Document 2: WO2004/018612
Patent Document 3: Japanese Patent Application Laid-Open Publication No. 2003-250503
Patent Document 4: WO2010/079643

### SUMMARY OF THE INVENTION

### Problems to be Solved by the Invention

The present invention aims at providing an alcohol-free beer-like malt beverage having an unpleasant wort off-flavor reduced and production process thereof.

### Means to Solve the Problem

The present inventors have found that the off-flavor originated from wort is reduced by adding terpene to the wort in the production of an alcohol-free beer-like malt beverage, and good flavor is obtained.

More specifically, the present inventors have found that the off-flavor originated from wort is reduced by adding terpene to the cooled wort in the production of an alcohol-free beer-like malt beverage, and good flavor is obtained.

In addition, the present inventors have found that the off-flavor originated from wort is reduced by adding terpene to the wort after boiling treatment and before cooling in the production of an alcohol-free beer-like malt beverage, and good flavor is obtained. Furthermore, the present inventors have found that the composition ratio of terpenes changes by heating of terpene and multiple kinds of terpene are present in the finished malt beverage in a certain concentration, respectively.

Thus, according to the present invention, a method for producing an alcohol-free beer-like malt beverage is provided, the method comprising reducing the off-flavor originated from wort by adding terpene. Furthermore, according to the present invention, an alcohol-free beer-like malt beverage produced by the method is provided.

In particular, according to the first aspect of the present invention in which terpene is not heated, the following invention is provided.

(1) A method for producing an alcohol-free beer-like malt beverage comprising reducing the off-flavor originated from wort by adding terpene, wherein the terpene is not heat treated.

(2) The method according to item (1), wherein the terpene is added after completion of cooling of the wort obtained by boiling process of the wort.

(3) The method according to item (1), wherein the terpene is terpinolene.

(4) The method according to item (3), wherein terpinolene is added so that the ion intensity of 121 m/z is not less than 185% and is less than 22555% relative to the ion intensity of 110 m/z attributable to borneol in the GC/MS analysis of the malt beverage using 25 ppb of borneol as the internal standard.

(5) An alcohol-free beer-like malt beverage produced by the method according to any one of the items (1) to (4).

(6) An alcohol-free beer-like malt beverage containing terpinolene, wherein terpinolene concentration in the malt beverage is adjusted so that the ion intensity of 121 m/z is not less than 185% and is less than 22555% relative to the ion intensity of 110 m/z attributable to borneol in the GC/MS analysis of the malt beverage using 25 ppb of borneol as the internal standard.

Furthermore, according to the second aspect of the present invention in which terpenes are heated, the following invention is provided.

(1) A method for producing an alcohol-free beer-like malt beverage comprising reducing the off-flavor originated from wort by adding terpene, wherein the terpene is heat treated.

(2) The method according to item (1), wherein the terpene is added before completion of the cooling process in the case that the method comprises the wort boiling process and the subsequent cooling process.

(3) The method according to item (1), wherein the terpene is heat treated previously before being added to the wort.

(4) The method according to item (1), wherein the terpene is terpinolene.

(5) The method according to item (4), wherein terpinolene is added so that the ion intensity of 121 m/z is not less than 40% and is less than 185% relative to the ion intensity of 110 m/z attributable to borneol as the index of terpinolene concentration, the ion intensity of 81 m/z is not less than 13% and is less than 60% relative to the ion intensity of 110 m/z attributable to borneol as the index of D-fenchyl alcohol concentration, and the ion intensity of 91 m/z is not less than 1% and is less than 5% relative to the ion intensity of 110 m/z attributable to borneol as the index of p-cymen-8-ol concentration, in the GC/MS analysis of the malt beverage using 25 ppb of borneol as the internal standard.

(6) A method for producing an alcohol-free beer-like malt beverage comprising reducing the off-flavor originated from wort by adding terpinolene, D-fenchyl alcohol and p-cymen-8-ol.

(7) The method according to item (6), wherein terpinolene, D-fenchyl alcohol and p-cymen-8-ol are added so that the ion intensity of 121 m/z is not less than 40% and is less than 185% relative to the ion intensity of 110 m/z attributable to borneol as the index of terpinolene concentration, the ion intensity of 81 m/z is not less than 13% and is less than 60% relative to the ion intensity of 110 m/z attributable to borneol as the index of D-fenchyl alcohol concentration, and the ion intensity of 91 m/z is not less than 1% and is less than 5% relative to the ion intensity of 110 m/z attributable to borneol as the index of p-cymen-8-ol concentration, in the GC/MS analysis of the malt beverage using 25 ppb of borneol as the internal standard.

(8) An alcohol-free beer-like malt beverage produced by the method according to any one of the items (1) to (7).

(9) An alcohol-free beer-like malt beverage containing terpinolene, D-fenchyl alcohol and p-cymen-8-ol, wherein the ion intensity of 121 m/z is not less than 40% and is less than 185% relative to the ion intensity of 110 m/z attributable to borneol as the index of terpinolene concentration, the ion intensity of 81 m/z is not less than 13% and is less than 60% relative to the ion intensity of 110 m/z attributable to borneol as the index of D-fenchyl alcohol concentration, and the ion intensity of 91 m/z is not less than 1% and is less than 5% relative to the ion intensity of 110 m/z attributable to borneol as the index of p-cymen-8-ol concentration, in the GC/MS analysis of the malt beverage using 25 ppb of borneol as the internal standard.

The alcohol-free beer-like malt beverage according to the present invention is advantageous in that the unpleasant wort flavor has been reduced although the unfermented or low fermented wort is used. Especially, it is advantageous in that the needs of the consumers for alcohol-free beverage with a rich beer flavor are simultaneously satisfied.

### BRIEF DESCRIPTION OF THE DRAWINGS

FIG. 1 shows a GC/MS chromatogram of the terpinolene fragrance before heat treatment.

FIG. 2 shows a GC/MS chromatogram of the solution of hot water at 80° C. with terpinolene added and warmed for 1 hr.

FIG. 3 shows a GC/MS chromatogram of the solution of hot water at 50° C. with terpinolene added and warmed for 1 hr.

FIG. 4 shows a GC/MS chromatogram of the solution of hot water at 60° C. with terpinolene added and warmed for 1 hr.

### DETAILED DESCRIPTION OF THE INVENTION

### Definition

In the present invention, “malt beverage” means a beverage predominantly composed of wort, including malt refreshing beverage with a cooling sensation given by carbon dioxide or the like.

In the present invention, “beer-like” means that the malt beverage exhibits the taste and flavor peculiar to beer which are obtained by usual brewing, i.e., brewing based on fermentation by yeast and the like.

In the present invention, “alcohol-free” means that alcohol originated from yeast fermentation is not contained, i.e., the alcohol content originated from yeast fermentation is 0.00 wt %.

In the present invention, “wort flavor” means a flavor peculiar to unfermented wort. Such flavor peculiar to unfermented wort includes an unpleasant flavor (also referred to as “off-flavor” in this specification) such as candy-like smell and grain-like smell generated by heat decomposition during boiling of the wort. These smells are considered to originate from aldehydes. In addition, “reducing” off-flavor means making off-flavor unperceivable to human olfaction in the present invention.

### Production Method of Malt Beverage

According to the present invention, terpene are added during the production process of the alcohol-free beer-like malt beverage, which results in reducing the off-flavor originated from wort and enables to obtain good flavor. Thus, according to the present invention, a method for producing an alcohol-free beer-like malt beverage comprising reducing the off-flavor originated from wort by adding terpene is provided. In addition, according to another aspect of the present invention, a method for reducing the off-flavor originated from wort comprising adding terpene during the production process of the alcohol-free beer-like malt beverage is provided.

In the method according to the first aspect of the present invention, terpene used in the above-mentioned method is not subject to heat treatment. In other words, terpene to be added are used without heat treatment and the wort is managed avoiding heat treatment after terpene is added to the wort. “Heat treatment” herein means the treatment at a temperature at which the terpene used is altered (for example, alteration in chemical structure), such as the treatment at a temperature of 50° C. or higher.

On the other hand, according to the second aspect of the present invention, terpene used in the above-mentioned method is heat treated at any stage. For example, terpene may be previously heat treated before being added to the wort. Alternatively, if the heat treatment process such as the wort boiling process is included in the production process of the malt beverage, terpene may be heat treated by adding terpene to the wort before or during that process. Furthermore, the heat treatment of terpene is possible even after completion of the heat treatment process such as the wort boiling process, so long as the necessary temperature is maintained. Therefore, terpene may be heat treated by adding terpene to the wort before completion of cooling of the wort. “Heat treatment” herein means the treatment at a temperature at which the terpene used is altered (for example, alteration in chemical structure), such as the treatment at a temperature of 50° C. or higher. The treatment time may be determined appropriately confirming the alteration of terpene and thus is not particularly limited. The treatment time is preferably 5 to 90 minutes, more preferably 40 to 80 minutes, most preferably about 60 minutes.

Terpene added to the wort in the present invention may be any substances known as terpene-based compound and thus are not particularly limited. Terpene is preferably terpenoids, more preferably monoterpene. Examples of monoterpene include myrcene, ocimene, cosmene, menthane, limonene, terpinolene, terpinene, menthol, cymene, fenchyl alcohol, etc.

According to a preferred embodiment of the present invention, terpene to be added to the wort is terpinolene. In the method according to the first aspect of the present invention, as the concentration of terpinolene in the finished alcohol-free beer-like malt beverage, the ion intensity of 121 m/z originated from terpinolene is preferably not less than 185% and less than 22555%, more preferably 370% to 9000%, relative to the ion intensity of 110 m/z attributable to borneol in the GC/MS analysis of the malt beverage using 25 ppb of borneol as the internal standard. Thus, the amount of terpinolene to be added to the wort is determined so that the finished alcohol-free beer-like malt beverage contains terpinolene at such concentration. In the case that other terpene is added to the wort, the amount to be added may be determined referring to the above-mentioned preferred concentration range of terpinolene.

In addition, in the case that terpinolene is used in the method according to the second aspect of the present invention, as the concentration of terpinolene in the finished alcohol-free beer-like malt beverage, the ion intensity of 121 m/z originated from terpinolene is preferably not less than 40% and less than 185% relative to the ion intensity of 110 m/z attributable to borneol in the GC/MS analysis of the malt beverage using 25 ppb of borneol as the internal standard. Furthermore, among the other substances generated by the heat treatment of terpinolene, what are considered especially important are D-fenchyl alcohol and p-cymen-8-ol. Thus, as the concentration of D-fenchyl alcohol in the finished alcohol-free beer-like malt beverage, the ion intensity of 81 m/z originated from D-fenchyl alcohol is preferably not less than 13% and less than 60%, more preferably not less than 40% and less than 60%, relative to the ion intensity of 110 m/z attributable to borneol in the GC/MS analysis of the malt beverage using 25 ppb of borneol as the internal standard. As the concentration of p-cymen-8-ol in the finished alcohol-free beer-like malt beverage, the ion intensity of 91 m/z originated from p-cymen-8-ol is preferably not less than 1% and less than 5%, more preferably not less than 2% and less than 5%, relative to the ion intensity of 110 m/z attributable to borneol in the GC/MS analysis of the malt beverage using 25 ppb of borneol as the internal standard. Thus, the amount of terpinolene to be added to the wort is determined so that the finished malt beverage contains terpinolene, D-fenchyl alcohol and p-cymen-8-ol at such concentration. In the case that terpene other than terpinolene is added to the wort, the amount to be added may be determined referring to the above-mentioned preferred concentration range of terpinolene, D-fenchyl alcohol and p-cymen-8-ol.

As mentioned above, in the case that terpinolene is used in the method according to the second aspect of the present invention, D-fenchyl alcohol and p-cymen-8-ol are generated by the heat treatment of terpinolene. It is believed that the off-flavor originated from wort is reduced by these three components acting as the effective components. According to this finding, reduction of off-flavor should be also achieved by adding these three components to the wort, regardless of the presence or absence of the heat treatment of terpinolene. Therefore, according to another aspect of the present invention, a method for producing an alcohol-free beer-like malt beverage comprising reducing the off-flavor originated from wort by adding terpinolene, D-fenchyl alcohol and p-cymen-8-ol is provided. The preferred concentration of the three components in this aspect is as mentioned above. In addition, it is preferable that the three components to be added are not heat treated. For this purpose, for example, as the three components to be added, those which have not been heat treated are used and, after adding them to the wort, the wort is managed so that it is not heat treated.

As solubility of many terpenes to water is low, it is preferable that the generally used solubility enhancing techniques, including homogenizing terpene using glycerin fatty acid esters, be used when adding terpene to the wort. However, these solubility enhancing techniques are not always necessary when terpene is added to aqueous solvent at high temperature or when heat treatment is performed after adding terpene to aqueous solvent.

General production method of alcohol-free beer-like malt beverage is well known in the art and thus is not particularly limited. The method typically includes a preparation process of wort and a filtration process of malt beverage. For example, these processes may be performed as follows.

The preparation process of the wort may be performed according to the conventional method. For example, the wort may be obtained by performing (a) a process to saccharify the mixture of pulverized malt and water and filtrate it to obtain the wort, (b) a process to add hop to the wort obtained followed by boiling, and (c) a process to cool the boiled wort.

In the process (a), the pulverized malt may be obtained by germinating barley, such as two-rowed barley, according to the conventional method and pulverizing the malt obtained to the predetermined particle size after drying.

Auxiliary materials may be added to the mixture of pulverized malt and water. Examples of the auxiliary materials include rice, cornstarch, corn grits, sugars (for example, liquid sugar such as high fructose corn syrup), dietary fiber, etc. If the auxiliary material is a sugar, it may be added after saccharification and/or filtration of the wort. Water may be mixed with the pulverized malt all together. Alternately, a part of water may be mixed with the pulverized malt and the rest may be added to the wort after saccharification all together or by portions.

The ratio of the pulverized malt, auxiliary material and water which constitute the wort may be determined appropriately. The ratio may be determined so that the sugar content obtained after the process (c) becomes 3 to 20%, preferably 7 to 14%. The ratio of the pulverized malt, auxiliary material and water may be, for example, 0 to 100 weight parts of auxiliary material and 400 to 2000 weight parts of water, preferably 0 to 30 weight parts of auxiliary material and 600 to 1300 weight parts of water, based on 100 weight parts of the pulverized malt. If the auxiliary materials are high fructose corn syrup and dietary fiber, the ratio of the pulverized malt, auxiliary material and water may be, for example, 10 to 40 weight parts of auxiliary material and 800 to 1500 weight parts of water, preferably 20 to 30 weight parts of auxiliary material and 1000 to 1200 weight parts of water, based on 100 weight parts of the pulverized malt. In this case, the weight ratio of high fructose corn syrup and dietary fiber (solid content) may be 1:0.1 to 10.

Saccharification and filtration of the above-mentioned mixture may be performed according to the conventional method.

In process (b), taste and flavor of hop may be decocted by boiling after adding hop to the wort obtained in process (a). Lees composed of protein and the like precipitated may be removed after boiling.

In process (c), the boiled wort is cooled. Cooling is preferably done down to as low temperature as possible, at which the wort does not freeze, usually to 1 to 5° C.

Additives such as fragrance, dye, foaming agent, foam retention improving agent, etc. may be added to the wort. These additives may be added before saccharification of the wort or after saccharification and/or filtration of the wort.

Unnecessary protein and/or adsorbent may be removed by filtering the wort obtained as mentioned above. Filtration may be performed according to the conventional method. For filtration, it is preferable to use a diatomite filter. Sugar content of the final product may be adjusted to 3 to 8% by diluting the wort beverage by adding deaerated water followed by filtration.

After filtration, some processes usually performed in the production of conventional beer or sparkling liquor, such as adjustment of the final concentration by deaerated water and the like, inclusion of carbon dioxide, packaging into a container (such as barrel, bottle or can), labeling of the container, etc. may be performed appropriately.

According to another aspect of the present invention, an additive for reducing the off-flavor originated from wort in alcohol-free beer-like malt beverage, which comprises terpene, preferably terpinolene, is provided. According to yet another aspect of the present invention, an additive for reducing the off-flavor originated from wort in alcohol-free beer-like malt beverage, which comprises heat treated terpene, preferably heat treated terpinolene, is provided. According to yet another aspect of the present invention, an additive for reducing the off-flavor originated from wort in alcohol-free beer-like malt beverage, which comprises terpinolene, D-fenchyl alcohol and p-cymen-8-ol, is provided. These additives may be provided in a form easily soluble to water, for example, in a form of emulsion prepared using glycerin fatty acid esters.

### EXAMPLES

The present invention will be illustrated specifically based on the following examples. The present invention is not limited to these examples.

### Example 1

### Influence of Addition of Terpene on the Taste of Wort (without Heating of Terpene)

### (1) Preparation of Wort Samples

Wort samples were prepared using a 1.5 L scale apparatus. First, cooled wort with a sugar content adjusted to 4.2° (usage ratio of malt at feeding: 24.0%, usage ratio of auxiliary material (barley, liquid sugar and corn grits): 76.0%) was prepared and terpinolene (produced by a domestic fragrance company) was added to this cooled wort at different concentrations. At this time, terpinolene was emulsified using conventionally used glycerin fatty acid ester before adding to the cooled wort, because terpinolene has a poor solubility to water. Thus, each of the wort samples of test samples 1 to 12 was obtained.

### (2) Sensory Evaluation

As the sensory evaluation items, three items composed of strength of wort off-flavor, strength of odor originated from terpinolene, and total balance of these flavors taken together were set. Specific definitions of each evaluation item are shown below.

a. Wort off-flavor: Flavor peculiar to wort, which is wheat-like, malt-like, or grain-like sticky and sweet flavor. Evaluation was done in four grades, i.e., none, weak, medium and strong.

b. Odor originated from terpinolene: Odor denoted by cider-like, citrus-like, machine oil-like, or wood-like. Evaluation was done in four grades, i.e., none, weak, medium and strong.

c. Total balance: Degree of balance between reducing effect on wort off-flavor and odor originated from terpinolene. Evaluation was done by whether the flavor is good or not. The degree of balance was evaluated in three grades, i.e., poor: not favorable (wort off-flavor or odor originated from terpinolene is out of acceptable range), acceptable: favorable in acceptable range (reducing effect on wort off-flavor is weak, or a little odor originated from terpinolene is felt but within acceptable range), and good: favorable (wort off-flavor is strongly suppressed and odor originated from terpinolene is hardly or not felt).

(3) Calculation of Concentration of Index Components by Analysis of Terpinolene Concentration Using Gas Chromatography with Mass Spectrometer (GC/MS)

Quantitative determination of terpinolene was performed by GC/MS analysis, because the purity of terpinolene fragrance is not 100%. The fragrance components were extracted using C18 solid phase column and the extract was subjected to GC/MS analysis. In this quantitative method, the quantitative value was defined as the relative intensity of the specific ion of the object substance represented by percentage (%) relative to the response of an ion 110 m/z of a substance added as the internal standard. Borneol was used as the internal standard and added to the wort sample so that its concentration is 25 ppb. Analytical conditions of the fragrance components in GC/MS analysis are shown in Table 1.

TABLE 1
Analytical conditions of GC/MS

| | |
|---|---|
| Capillary column | Commercial name: HP-INNOWAX |
| | (Length 60 m, inner diameter 0.25 mm, |
| | membrane thickness 0.25 μm) |
| Oven temperature | 40° C., 0.3 min [symbol] 3° C./min [symbol] |
| | 240° C., 20 min |
| Carrier gas | He, 10 psi low pressure air supply |
| Transfer line temperature | 240° C. |
| MS Ion source temperature | 230° C. |
| MSQ Pole temperature | 150° C. |
| Front injection port temperature | 200° C. |
| Monitored ion | m/z = 110, 121 |
| Ion used for quantification | Terpinolene m/z = 121 |

### (4) Results

Results of the sensory evaluation and quantification by the GC/MS analysis mentioned above are shown in Table 2 along with the additive concentration of terpinolene fragrance in the wort samples.

TABLE 2
Test of terpinolene addition

| Test sample | | 1 | 2 | 3 | 4 | 5 | 6 | 7 | 8 | 9 | 10 | 11 | 12 |
|---|---|---|---|---|---|---|---|---|---|---|---|---|---|
| concentration of terpinolene | | None | 0.01 | 0.02 | 0.04 | 0.05 | 0.1 | 0.2 | 0.5 | 1 | 2 | 5 | 10 |
| added, ppm | | | | | | | | | | | | | |
| Results of | Strength of | Strong | Strong | Strong | Strong | Medium | Weak | Weak | Weak | Weak | Weak | None | None |
| sensory test | wort flavor | | | | | | | | | | | | |
| | Odor originated | None | None | None | None | None | None | None | Weak | Weak | Weak | Medium | Strong |
| | from terpinolene | | | | | | | | | | | | |
| | Total balance | Poor | Poor | Poor | Poor | Accept- | Good | Good | Good | Good | Good | Accept- | Poor |
| | | | | | | able | | | | | | able | |

| | | | | | | | | | | | | |
|---|---|---|---|---|---|---|---|---|---|---|---|---|
| Terpinolene analyzed value (%) | 13.2 | 36.4 | 72.8 | 126.9 | 182.1 | 364.2 | 728.4 | 2310.8 | 4511.1 | 9022.1 | 22555.3 | 45110.6 |
| (*1) | | | | | | | | | | | | |

(*1): Response ratio of quantitated ion 121 m/z relative to ion 110 m/z of internal standard (borneol)

As a result of the sensory evaluation, since strong off-flavor originated from wort was felt in test samples 1, 2, 3 and 4, the wort off-flavor was determined “strong” and the total balance was determined “poor”. In test samples 5, 6, 7, 8, 9, 10 and 11, since the off-flavor originated from wort reduced as the additive concentration increased and other off-flavors did not occur, the wort off-flavor was determined “medium” or “weak” or “none”, odor originated from terpinolene was determined “none”, and the total balance was determined “acceptable” or “good”. However, very little odor originated from terpinolene was felt in test samples 8, 9 and 10, where terpinolene was added in a relatively high concentration, as suggested in the preliminary test, odor originated from terpinolene was determined “weak”. However, since the odor did not affect the total flavor and reducing effect on the wort off-flavor was rather desirable, the total balance was determined “acceptable”. In test sample 11, since the off-flavor originated from terpinolene was relatively high (although favorable in an acceptable range) compared to the reducing effect on wort off-flavor, the odor originated from terpinolene was determined “medium”. Therefore, the balance was determined “acceptable”, although the wort off-flavor was determined “none”. In test sample 12, where the additive concentration was the maximum in these experiments, the flavor balance was considerably degraded due to the off-flavor originated from terpinolene, resulting in “poor” in the evaluation of flavor balance.

Accordingly, the test samples where the wort off-flavor was reduced and the flavor originated from terpinolene was harmonized with the total flavor balance without loss of the balance were test samples 5, 6, 7, 8, 9, 10 and 11, more preferably test samples 6, 7, 8, 9 and 10.

Then, according to the comparison between the results of the sensory evaluation and the quantification of terpinolene by GC/MS analysis, the quantitative range of the values of terpinolene where the wort off-flavor was effectively reduced and the flavor was improved was as follows. First, the favorable concentration of terpinolene to obtain the wort off-flavor reducing effect was not less than 182.1% as the response ratio of the quantitated ion 121 m/z relative to the ion 110 m/z of the internal standard borneol which was added so that its concentration in the wort sample was ppb. On the other hand, the favorable concentration of terpinolene to suppress the off-flavor originated from terpinolene was less than 22555.3% as the response ratio of the quantitated ion 121 m/z relative to the ion 110 m/z of the internal standard borneol which was added so that its concentration in the wort sample was 25 ppb.

### (5) Analytical Results of Commercially-Available Products

Table 3 shows the terpinolene concentration in the products of alcohol-free beverages supplied by various domestic companies. It was found that these concentrations were significantly lower than the above-mentioned preferred concentration range.

TABLE 3
Analytical values of commercial products

| | Commercial | Commercial | Commercial | Commercial |
|---|---|---|---|---|
| | product A | product B | product C | product D |
| Characteristics | Malt | Corn-like | Strong wort | Wort flavor |
| of flavor | feeling, | grain flavor, | flavor, | is felt, |
| | grain-like, | artificial | sticky, | although |
| | sweetness, | flavor like | strong | weaker |
| | artificial | soap, | sweetness | than |
| | banana | artificial | | commercial |
| | flavor | banana | | product C |
| Concentration | 1.4 | 3.1 | 1.1 | 1.6 |
| % (*) | | | | |
| Terpinolene | | | | |

(*) Response ratio of ion 121 m/z relative to ion 110 m/z of internal standard borneol

### Example 2

### Influence of Addition of Terpene on the Taste of Wort (with Heating of Terpene)

### (1) Preparation of Wort Samples

Wort samples were prepared using a 1.5 L scale apparatus. Specifically, cooled wort with a sugar content adjusted to 4.2° (usage ratio of malt at feeding: 24.0%, usage ratio of auxiliary material (barley, liquid sugar and corn grits): 76.0%) was prepared. In this preparation process of the cooled wort, terpinolene (produced by a domestic fragrance company) of different concentrations was added directly to the hot wort after boiling without using any carrier such as emulsifier. The mixture was kept warm at 80° C. for 1 hour and cooled with ice. Thus, each of the wort samples of test samples 1 to 10 was obtained.

### (2) Sensory Evaluation

As the sensory evaluation items, three items composed of strength of wort off-flavor, strength of odor originated from fragrance, and total balance of these flavors taken together were set. Specific definitions of each evaluation item are shown below.

a. Wort off-flavor: Flavor peculiar to wort, which is wheat-like, malt-like, or grain-like sticky and sweet flavor. Evaluation was done in four grades, i.e., none, weak, medium and strong.

b. Odor originated from fragrance: Odor denoted by resin-like, fungi-like, soil-like, or metal-like. Evaluation was done in four grades, i.e., none, weak, medium and strong.

c. Total balance: Degree of balance between reducing effect on wort off-flavor and odor originated from fragrance. Evaluation was done by whether the flavor is good or not. The degree of balance was evaluated in four grades, i.e., poor: clearly not favorable (wort off-flavor or odor originated from fragrance is out of acceptable range), unclear: decision whether acceptable or not is difficult. (reducing effect on wort off-flavor is weak, or odor originated from fragrance is a little strong, therefore it is difficult to decide favorable or not.), acceptable: favorable in acceptable range (reducing effect on wort off-flavor is weak, or a little odor originated from fragrance is felt but within acceptable range), and good: favorable (wort off-flavor is strongly suppressed and odor originated from fragrance is hardly or not felt).

### (3) Results of the Sensory Evaluation

Results of the sensory evaluation mentioned above are shown in Table 4 along with the additive concentration of terpinolene fragrance in the wort samples.

TABLE 4
Results of sensory evaluation with terpinolene added

| Test sample | | 1 | 2 | 3 | 4 | 5 | 6 | 7 | 8 | 9 | 10 |
|---|---|---|---|---|---|---|---|---|---|---|---|
| Concentration of terpinolene added | | 0 | 0.025 | 0.05 | 0.1 | 0.25 | 0.4 | 0.5 | 5 | 10 | 20 |
| Results of sensory test | Strength of | Strong | Strong | Strong | Medium | Weak | Weak | Weak | None | None | None |
| | wort flavor | | | | | | | | | | |
| | Odor orignated | None | None | None | None | None | None | None | Medium | Strong | Strong |
| | from fragrance | | | | | | | | | | |
| | Total balance | Poor | Poor | Poor | Acceptable | Good | Good | Good | Unclear | Poor | Poor |

As a result of the sensory evaluation, since strong off-flavor originated from wort was felt in test samples 1 (sample without terpinolene added), 2 and 3, the wort off-flavor was determined “strong” and the total balance was determined “poor”. In test sample 4, since the reducing effect on wort off-flavor was felt although not significant, the wort off-flavor was determined “medium” and the total balance was determined “Acceptable”. In test samples 5, 6 and 7, since the off-flavor originated from wort was strongly suppressed and other off-flavors did not occur, the wort off-flavor was determined “weak”, odor originated from fragrance was determined “none”, and the total balance was determined “good”. In test sample 8, however, where terpinolene was added in a relatively high concentration, since the off-flavor originated from fragrance was relatively high (although favorable in an acceptable range) compared to the reducing effect on wort off-flavor, although the wort off-flavor was determined “none”, the odor originated from fragrance was determined “medium”, and the balance was determined “unclear”. In test samples 9 and 10, the off-flavor originated from fragrance was significantly distinct compared to other fragrances and caused unfavorable influence on the flavor, resulting in “poor” in the evaluation of flavor balance.

Accordingly, the test samples where the wort off-flavor was reduced and the flavor originated from terpinolene (fragrance) was harmonized with the total flavor balance without loss of the balance were test samples 4, 5, 6 and 7, more preferably test samples 5, 6 and 7.

(4) Calculation of Concentration of Index Components by Analysis of Terpinolene Concentration Using Gas Chromatography with Mass Spectrometer (GC/MS)

The reducing effect on wort off-flavor and the degree of odor originated from fragrance were investigated from chemical analysis values. Considering a possibility that the additive concentration and residual concentration do not coincide due to evaporation and the like, since terpinolene is added to hot wort, the terpinolene concentration after addition was quantified using GC/MS analysis. The fragrance components were extracted using C18 solid phase column and the extract was subjected to GC/MS analysis. In this quantitative method, the quantitative value was defined as the relative intensity of the specific ion of the object substance represented by percentage (%) relative to the response of an ion 110 m/z of a substance added as the internal standard. Borneol was used as the internal standard and added to the wort sample so that its concentration is 25 ppb. Analytical conditions of the hop fragrance components in GC/MS analysis are shown in Table 5.

TABLE 5
Analytical conditions of GC/MS

| | |
|---|---|
| Capillary column | Commercial name: HP-INNOWAX |
| | (Length 60 m, inner diameter 0.25 mm, |
| | membrane thickness 0.25 μm) |
| Oven temperature | 40° C., 0.3 min [symbol] 3° C./min [symbol] |
| | 240° C., 20 min |
| Carrier gas | He, 10 psi low pressure air supply |
| Transfer line temperature | 240° C. |
| MS Ion source temperature | 230° C. |
| MSQ Pole temperature | 150° C. |
| Front injection port temperature | 200° C. |
| Monitored ion | m/z = 81, 91, 110, 121 |
| Ion used for quantification | Terpinolene m/z = 121 |
| | D-fenchyl alcohol m/z = 81 |
| | p-cymen-8-ol m/z = 91 |

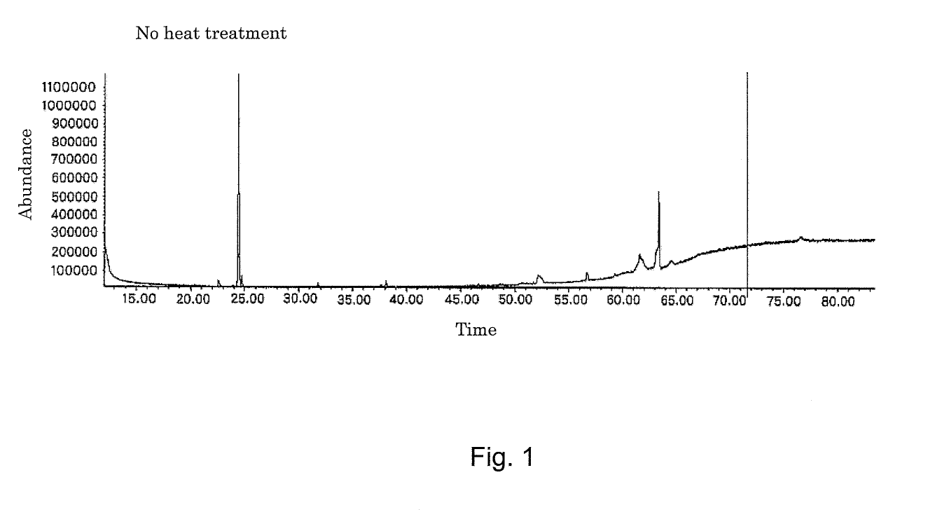

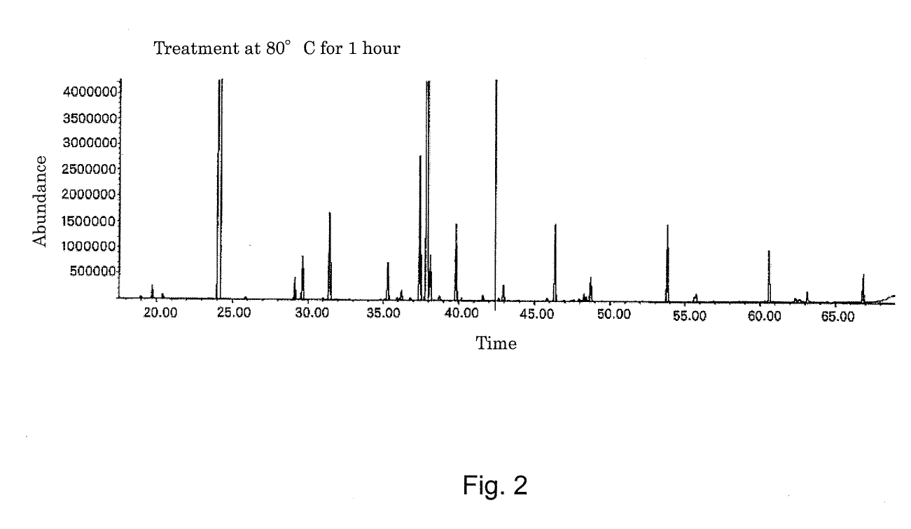

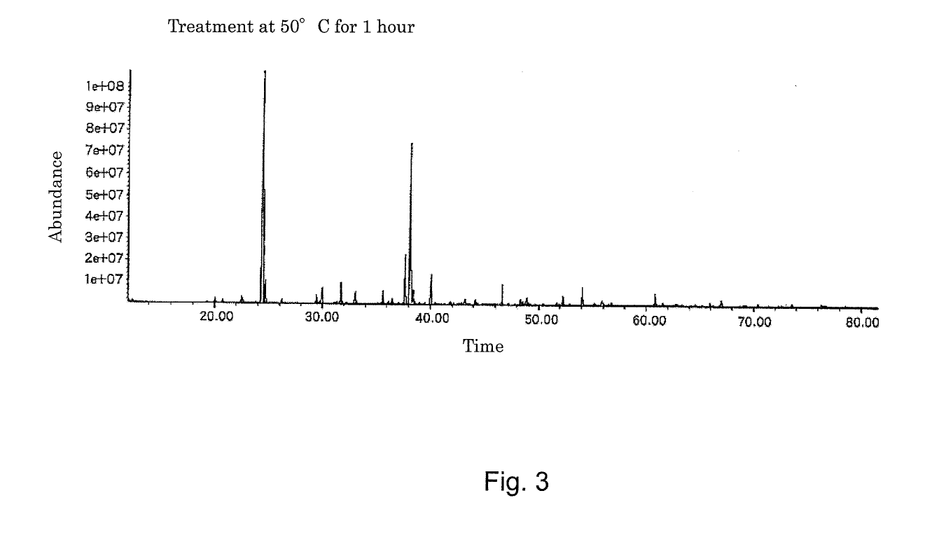

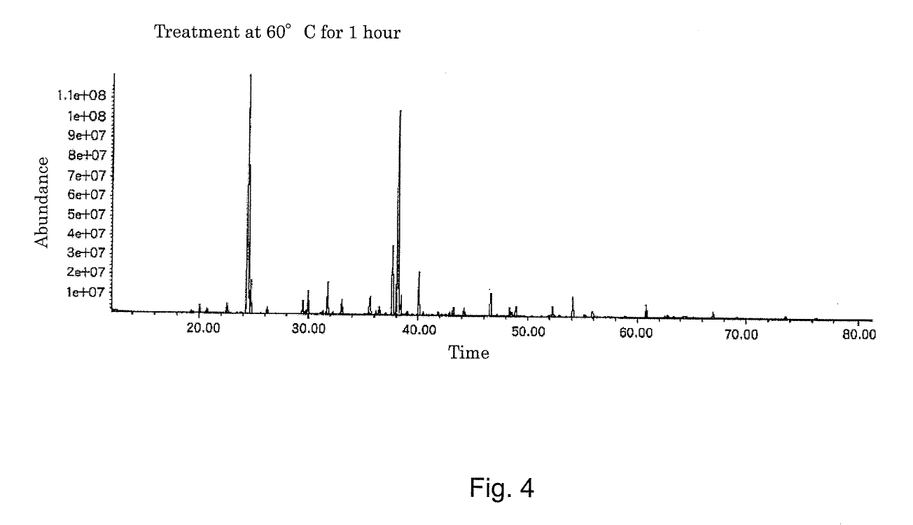

From the results of GC/MS analysis, presence of many substances other than terpinolene was confirmed. As a model, FIG. 1 shows a GC/MS chromatogram for analysis of terpinolene fragrance before heat treatment and FIG. 2 shows a GC/MS chromatogram of a solution of hot water at 80° C. with terpinolene added and warmed for 1 hour. In addition, it was confirmed that such change of substances is not limited to the treatment at 80° C. and that similar phenomenon occurs also by treatment at relatively high temperature of 50° C. and 60° C. (FIGS. 3 and 4).

Then, confirmation for these components revealed that they included 20 or more substances including unknown substances. These substances included, for example, gamma-terpinene, p-cymene, terpinolene, alpha-terpinene, fenchone, 1-methyl-4-(methylethenyl)benzene, terpinene-1-ol, D-fenchyl alcohol, beta-terpineol, p-cymen-8-ol, p-methyl acetophenone, etc. While not being bound by any particular theory, since these substances include terpene hydrocarbons and terpenoids having 10 carbon atoms similarly to terpinolene, it is supposed that some kind of chemical reaction occurred by direct addition of terpinolene to hot wort and a part of terpinolene was converted to a hydrate other than terpinolene, resulting in formation of these substances.

As a result of extensive investigation in order to identify a component which is consistent with and more relevant to the result of sensory evaluation among the substances mentioned above, attention was focused on D-fenchyl alcohol and p-cymen-8-ol in addition to terpinolene and GC/MS analysis was performed for these substances.

### (5) Comparison of the Results of Sensory Evaluation and Quantification by GC/MS Analysis

Results of the sensory evaluation and quantification of the GC/MS analysis mentioned above are shown in Table 6 along with the additive concentration of terpinolene fragrance in the wort samples.

TABLE 6
Results of sensory evaluation and component analysis with new additional component index

| Test sample | | | 1 | 2 | 3 | 4 | 5 | 6 | 7 | 8 | 9 | 10 |
|---|---|---|---|---|---|---|---|---|---|---|---|---|
| Concentration of terpinolene added | | | 0 | 0.025 | 0.05 | 0.1 | 0.25 | 0.4 | 0.5 | 5 | 10 | 20 |
| Results of sensory test | | Strength of | Strong | Strong | Strong | Medium | Weak | Weak | Weak | None | None | None |
| | | wort flavor | | | | | | | | | | |
| | | Odor originated | None | None | None | None | None | None | None | Medium | Strong | Strong |
| | | from fragrance | | | | | | | | | | |
| | | Total balance | Poor | Poor | Poor | Acceptable | Good | Good | Good | Unclear | Poor | Poor |
| Analytical | Component | m/z value | | | | | | | | | | |
| value | | of response | | | | | | | | | | |
| | Terpinolene | 121 | 1.0 | 3.9 | 19.4 | 37.7 | 41.6 | 148.0 | 184.8 | 680.8 | 691.9 | 669.6 |
| | D-Fenchyl alcohol | 81 | 0.6 | 3.9 | 6.5 | 12.5 | 40.2 | 48.0 | 59.9 | 593.7 | 1238.7 | 2343.5 |
| | p-cymen-8-ol | 91 | 0.2 | 0.3 | 0.7 | 1.1 | 2.3 | 3.9 | 4.9 | 46.9 | 106.5 | 180.3 |

From the results shown in Table 6, the quantitative range of the values of each component where the wort off-flavor was effectively reduced and the flavor was improved was as follows. First, the favorable concentration of each component to obtain the wort off-flavor reducing effect was not less than 37.7% for terpinolene (quantitated ion: 121 m/z), not less than 12.5% for D-fenchyl alcohol (quantitated ion: 81 m/z), and not less than 1.1% for p-cymen-8-ol (quantitated ion: 91 m/z) as the response ratio of the quantitated ions relative to the ion 110 m/z of the internal standard borneol which was added so that its concentration in the wort sample was 25 ppb. On the other hand, the favorable concentration of each component to suppress the off-flavor originated from the fragrance was less than 184.8% for terpinolene (quantitated ion: 121 m/z), less than 59.9% for D-fenchyl alcohol (quantitated ion: 81 m/z), and less than 4.9% for p-cymen-8-ol (quantitated ion: 91 m/z) as the response ratio of the quantitated ions relative to the ion 110 m/z of the internal standard borneol which was added so that its concentration in the wort sample was 25 ppb.

### (6) Analytical Results of Commercially-Available Products

Table 7 shows the concentration of the components mentioned above in the products of alcohol-free beverage supplied by various domestic companies. It was found that these concentrations were out of the above-mentioned preferred concentration range.

TABLE 7
Analytical values of commercial products

| | Commercial | Commercial | Commercial | Commercial |
|---|---|---|---|---|
| | product A | product B | product C | product D |
| Characteristics of flavor | Malt feeling, grain- | Corn-like grain | Strong wort flavor, | Wort flavor is felt, |
| | like, sweetness, | flavor, artificial | sticky, strong | although weaker |
| | artificial banana | flavor like soap, | sweetness | than commercial |
| | flavor | artificial banana | | product C |
| Terpinolene | 1.4 | 3.1 | 1.1 | 1.6 |
| D-fenchyl alcohol | 1.0 | 8.6 | 0.8 | 9.8 |
| p-cymen-8-ol | 0.6 | 0.8 | 0.4 | 0.5 |

*Quantitative values are the response % of each component relative to ion 110 m/z of internal standard borneol. Quantitated ions for each component are shown in Table 5.

1. A method for producing an alcohol-free beer-like malt beverage comprising reducing the off-flavor originated from wort by adding terpene.

2. The method according to claim 1, wherein the terpene is not heat treated.

3. The method according to claim 2, wherein the terpene is added after completion of cooling of the wort obtained by boiling process of the wort.

4. The method according to claim 2, wherein the terpene is terpinolene.

5. The method according to claim 4, wherein terpinolene is added so that the ion intensity of 121 m/z is not less than 185% and is less than 22555% relative to the ion intensity of 110 m/z attributable to borneol in the GC/MS analysis of the malt beverage using 25 ppb of borneol as the internal standard.

6. The method according to claim 1, wherein the terpene is heat treated.

7. The method according to claim 6, wherein the terpene is added before completion of the cooling process in the case that the method comprises the wort boiling process and the subsequent cooling process.

8. The method according to claim 6, wherein the terpene is heat treated previously before being added to the wort.

9. The method according to claim 6, wherein the terpene is terpinolene.

10. The method according to claim 9, wherein terpinolene is added so that the ion intensity of 121 m/z is not less than 40% and is less than 185% relative to the ion intensity of 110 m/z attributable to borneol as the index of terpinolene concentration, the ion intensity of 81 m/z is not less than 13% and is less than 60% relative to the ion intensity of 110 m/z attributable to borneol as the index of D-fenchyl alcohol concentration, and the ion intensity of 91 m/z is not less than 1% and is less than 5% relative to the ion intensity of 110 m/z attributable to borneol as the index of p-cymen-8-ol concentration, in the GC/MS analysis of the malt beverage using 25 ppb of borneol as the internal standard.

11. A method for producing an alcohol-free beer-like malt beverage comprising reducing the off-flavor originated from wort by adding terpinolene, D-fenchyl alcohol and p-cymen-8-ol.

12. The method according to claim 11, wherein terpinolene, D-fenchyl alcohol and p-cymen-8-ol are added so that the ion intensity of 121 m/z is not less than 40% and is less than 185% relative to the ion intensity of 110 m/z attributable to borneol as the index of terpinolene concentration, the ion intensity of 81 m/z is not less than 13% and is less than 60% relative to the ion intensity of 110 m/z attributable to borneol as the index of D-fenchyl alcohol concentration, and the ion intensity of 91 m/z is not less than 1% and is less than 5% relative to the ion intensity of 110 m/z attributable to borneol as the index of p-cymen-8-ol concentration, in the GC/MS analysis of the malt beverage using 25 ppb of borneol as the internal standard.

13. An alcohol-free beer-like malt beverage produced by the method according to claim 1.

14. An alcohol-free beer-like malt beverage containing terpinolene, wherein terpinolene concentration in the malt beverage is adjusted so that the ion intensity of 121 m/z is not less than 185% and is less than 22555% relative to the ion intensity of 110 m/z attributable to borneol in the GC/MS analysis of the malt beverage using 25 ppb of borneol as the internal standard.

15. An alcohol-free beer-like malt beverage containing terpinolene, D-fenchyl alcohol and p-cymen-8-ol, wherein the ion intensity of 121 m/z is not less than 40% and is less than 185% relative to the ion intensity of 110 m/z attributable to borneol as the index of terpinolene concentration, the ion intensity of 81 m/z is not less than 13% and is less than 60% relative to the ion intensity of 110 m/z attributable to borneol as the index of D-fenchyl alcohol concentration, and the ion intensity of 91 m/z is not less than 1% and is less than 5% relative to the ion intensity of 110 m/z attributable to borneol as the index of p-cymen-8-ol concentration, in the GC/MS analysis of the malt beverage using 25 ppb of borneol as the internal standard.
